(19) United States
(12) Patent Application Publication
(10) Pub. No.: US 2010/0103129 A1
(43) Pub. Date: Apr. 29, 2010

(54) ELECTRONIC DEVICE HAVING TOUCH MODULE

(75) Inventors: Kuo-Nan Ling, Taipei City (TW); Po-An Lin, Taipei City (TW); Yung-Hui Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/567,803

(22) Filed: Sep. 28, 2009

Related U.S. Application Data
(60) Provisional application No. 61/108,028, filed on Oct. 24, 2008.

(51) Int. Cl. G06F 3/041

(52) U.S. Cl. 345/173; 178/18.03

(57) ABSTRACT

An electronic device includes a housing, a touch module and a switch module. The housing has an opening and a supporting plate, wherein one side of the supporting plate is connected to the housing. The touch module is disposed over the supporting plate and one side connected to the housing. The switch module is disposed under the supporting plate and corresponding to a side of the touch module, wherein the side of the touch module is bent to turn on the switch module when a force is applied to the side of the touch module.

### CROSS-REFERENCE TO RELATED APPLICATION

This application claims the priority benefit of U.S. provisional application Ser. No. 61/108,028, filed on Oct. 24, 2008. The entirety of the above-mentioned patent application is hereby incorporated by reference herein and made a part of specification.

### BACKGROUND OF THE INVENTION

1. Field of the Invention

The present invention generally relates to an electronic device. More particularly, the present invention relates to an electronic device having a touch module.

2. Description of Related Art

In an electronic device, an input device is used to receive external information, such that the electronic device can operate according to the received information. In other words, the user can control the computer system to execute different functions by operating the input devices. For example, most common input devices of a notebook computer are the keyboard and the mouse. The user can use the keyboard to input a character or use the mouse to choose a file. In a notebook computer, aside from the keyboard, a touch module is often included to take over the mouse. All the input devices, such as the keyboard, mouse, or the touch module, enable the user to communicate with the computer system.

Currently, a switch module is disposed adjacent to the touch module on a housing of the notebook computer, wherein the switch module and the touch module are exposed by the housing respectively. Therefore, the operation area of the touch module is limited since the switch module and the touch module both occupy the area on the housing.

### SUMMARY OF THE INVENTION

The present invention is to provide an electronic device, wherein the operation area of the touch module is increased.

As embodied and broadly described herein, the present invention provides an electronic device includes a housing, a touch module and a switch module. The housing has an opening and a supporting plate, wherein one side of the supporting plate is connected to the housing. The touch module is disposed over the supporting plate and one side connected to the housing. The switch module is disposed under the supporting plate and corresponding to a side of the touch module, wherein the side of the touch module is bent to turn on the switch module when a force is applied to the side of the touch module.

According to an embodiment of the present invention, the supporting plate is integrated with the housing.

According to an embodiment of the present invention, the touch module includes a touch sensor and a top cover. The touch sensor is disposed on the surface of the supporting plate and is over the supporting plate. The top cover is disposed on the touch sensor.

According to an embodiment of the present invention, the touch module further includes a first adhesive layer and a second adhesive layer. The first adhesive layer is disposed between the top cover and the touch sensor. The second adhesive layer is disposed between the supporting plate and the touch sensor.

According to an embodiment of the present invention, the housing has at least a slot under the opening, and the supporting plate has at least an elastic connecting part inserted into the slot and connected to the housing, wherein the elastic connecting part is extended from a first side of the supporting plate and the side of the touch module is opposite to the elastic connecting part.

According to an embodiment of the present invention, the touch module includes a touch sensor, disposed on the surface of the supporting plate and is under the supporting plate.

According to an embodiment of the present invention, the touch module further includes an adhesive layer, disposed between the supporting plate and the touch sensor.

According to an embodiment of the present invention, the supporting plate has an engaged portion, extended from a second side of the supporting plate and contacted with an inner wall of the housing in the opening, wherein the second side is opposite to the first side.

According to an embodiment of the present invention, the housing has at least a first pivot portion in the opening and an elastic structure fixed in the opening, and the supporting plate has at least a second pivot portion extended from a first side of the supporting plate and pivoted to the first pivot portion, wherein the side of the touch module is opposite to the second pivot portion, and the supporting plate is supported by the elastic structure.

According to an embodiment of the present invention, the touch module includes a touch sensor, disposed on the surface of the supporting plate and is under the supporting plate.

According to an embodiment of the present invention, the touch module further includes an adhesive layer, disposed between the supporting plate and the touch sensor.

According to an embodiment of the present invention, the supporting plate has an engaged portion, extended from a second side of the top cover and contacted with an inner wall of the housing in the opening, wherein the second side is opposite to the first side.

According to an embodiment of the present invention, the elastic structure includes a fixed plate and at least an elastic element. The fixed plate is fixed in the opening. The elastic element is disposed on the fixed plate.

In summary, the switch module of the present invention is disposed under the touch module and is able to be turned on by a side of the touch module when a force is applied to the touch module. Thus, the operation area of the touch module is able to be increased since the switch module does not occupy the area on the housing. Besides, the manufacturing cost is decreased since it is no need to dispose a button on the housing for pressing the switch module.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view showing an embodiment of the electronic device of the present invention.

FIG. 2 is an exploded view showing parts of the electronic device in FIG. 1.

FIG. 3 is a schematic perspective view showing the housing in FIG. 2.

FIG. 4 is a cross-sectional view showing the touch module and the switch module in FIG. 3.

FIG. 5 is an exploded view showing another embodiment of parts of the electronic device of the present invention.

FIG. 6 is a schematic perspective view showing the top cover in FIG. 5.

FIG. 7 is an exploded view showing another embodiment of parts of the electronic device of the present invention.

FIG. 8 is a schematic perspective view showing the top cover in FIG. 7.

FIG. 9 is a schematic perspective view showing the housing in FIG. 7.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

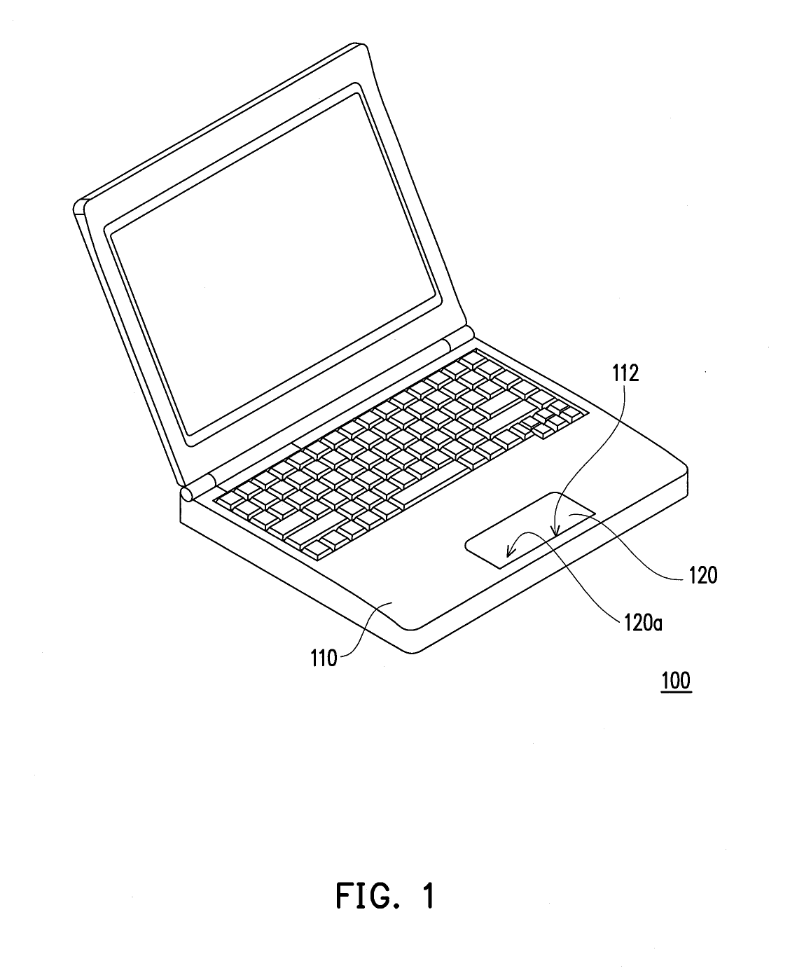

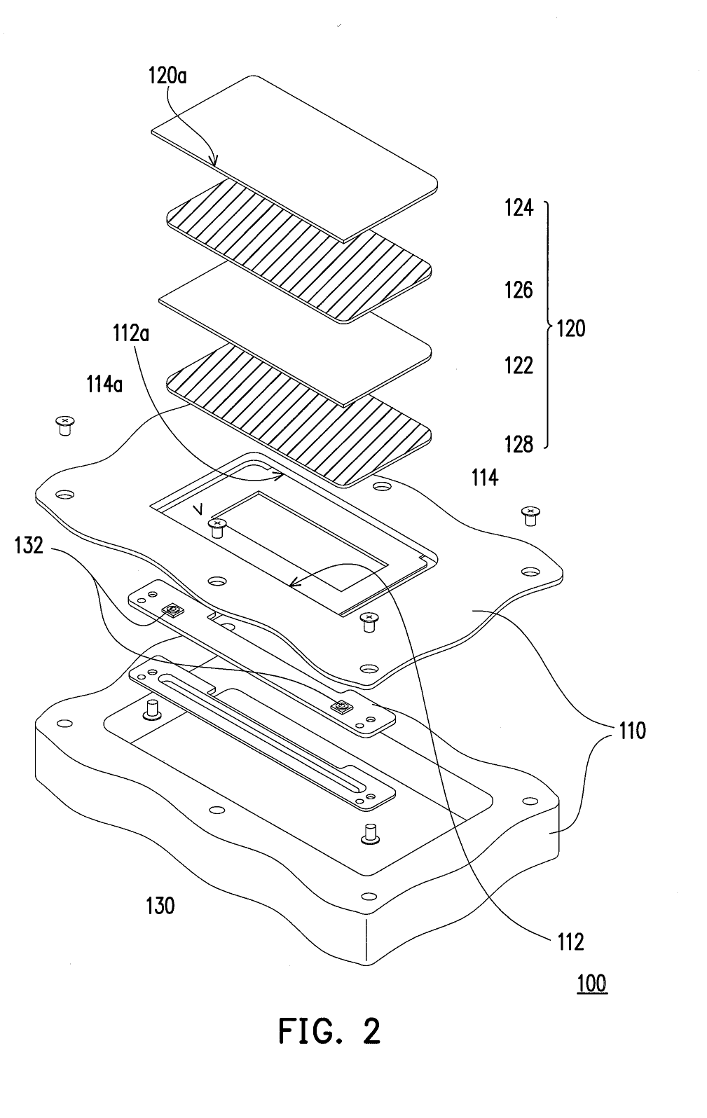

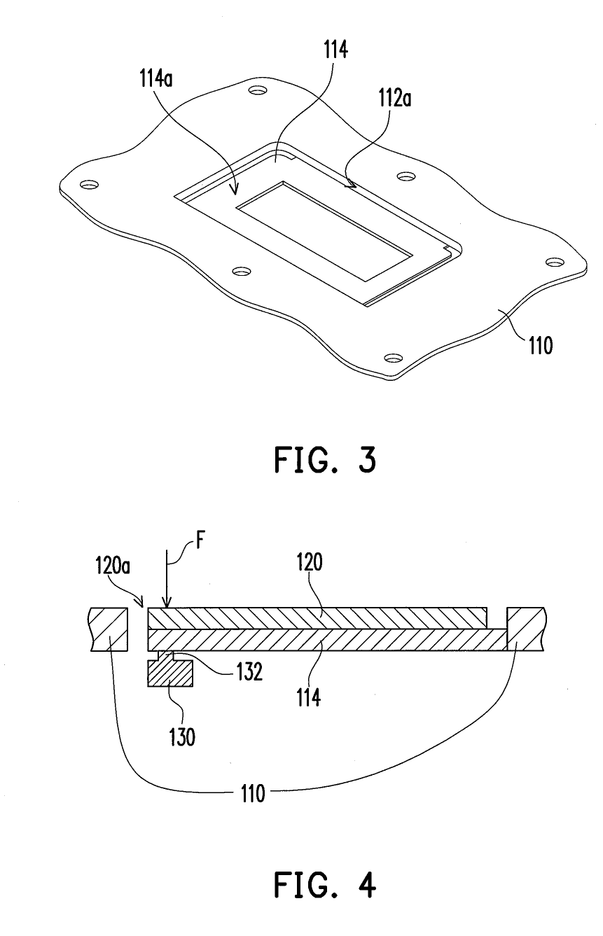

FIG. 1 is a schematic perspective view showing an embodiment of the electronic device of the present invention. FIG. 2 is an exploded view showing parts of the electronic device in FIG. 1. FIG. 3 is a schematic perspective view showing the housing in FIG. 2. Referring to FIG. 1, FIG. 2 and FIG. 3, the electronic device 100 includes a housing 110, a touch module 120 and a switch module 130. The housing 110 has an opening 112 and a supporting plate 114 extended from an inner side 112a of the opening 112, wherein the supporting plate 114 is integrated with the housing 110. The supporting plate 114 has a surface 114a suspended under the opening 112 and apt to be pressed. Referring to FIG. 1, the electronic device 100 is for example a notebook computer, and the housing 110 could be a part of the shell of the notebook computer.

The touch module 120 is disposed in the opening 112 and supported by the surface 114a. The switch module 130 is disposed in the housing 110 and corresponding to a side 120a of the touch module 120. FIG. 4 is a cross-sectional view showing the touch module and the switch module in FIG. 3. Referring to FIG. 2 and FIG. 4, the side 120a of the touch module 120 is opposite to the inner side 112a of the opening 112. Therefore, the side 120a and the supporting plate 114 are suitable for being bent to turn on the switch module 130 by a force F applied to the side 120a of the touch module 120. In this embodiment, the switch module 130 has two switches 132 for being turned on.

It is noticed that the switch module 130 is disposed under the touch module 120. Therefore, the switch module 130 does not occupy the area on the housing 110, such that the size and the operation area of the touch sensitive 120 are able to be increased.

Referring to FIG. 2, the touch module 120 includes a touch sensor 122 and a top cover 124 for protecting the touch sensor 122. The touch sensor 122 is disposed on the supporting plate 114 and the top cover 124 is disposed on the touch sensor 122. In addition, the touch module 120 further includes a first adhesive layer 126 and a second adhesive layer 128. The first adhesive layer 126 is disposed between the top cover 124 and the touch sensor 122 and the second adhesive layer 128 is disposed between the supporting plate 114 and the touch sensor 126, such that the top cover 124, the touch sensor 126 and the supporting plate 114 are fixed together.

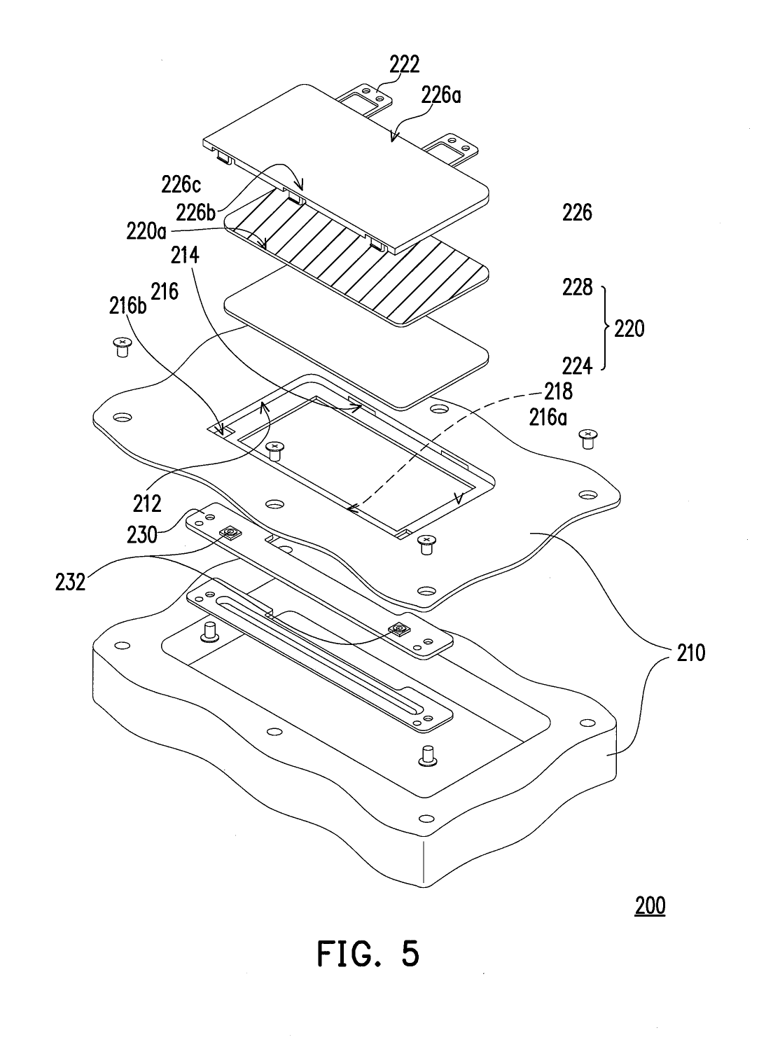

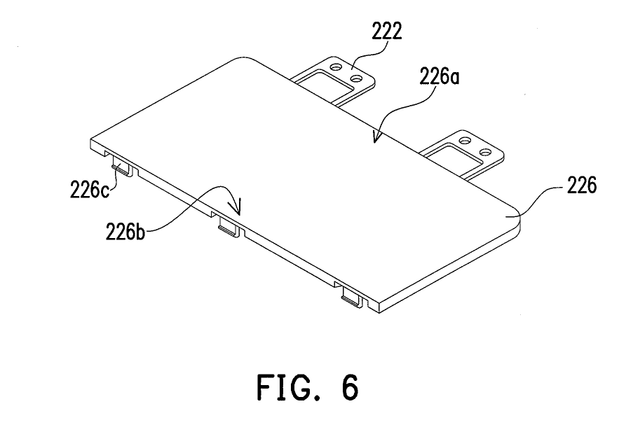

FIG. 5 is an exploded view showing another embodiment of parts of the electronic device of the present invention. FIG. 6 is a schematic perspective view showing the top cover in FIG. 5. Referring to FIG. 5 and FIG. 6, the electronic device 200 includes a housing 210, a touch module 220 and a switch module 230. The housing 210 has an opening 212, a supporting plate 226, at least a slot 214 (showing two) and a fixed plate 216 fixed in the opening 212, wherein the fixed plate 216 has a supporting surface 216a under the opening 212. The touch module 220 is adhered to the supporting plate 226 and supported by the supporting surface 216a, wherein the supporting plate 226 has at least an elastic connecting part 222 (showing two) inserted into the slot 214 and connected to the housing 210, so that the touch module 220 is apt to be pressed over the supporting surface 216a. The housing 210 could be a part of a shell of a notebook computer. In other words, the housing 210 is able to be integrated with a shell of a notebook computer by manufacturing.

The switch module 230 is disposed in the housing 210 and corresponding to a side 220a of the touch module 220, wherein the side 220a of the touch module 220 is opposite to the elastic connecting part 222 and is suitable for being bent by the elastic deformation of the elastic connecting part 222 to turn on the switch module 230 by a force applied to the side 220a of the touch module 220. In this embodiment, the switch module 230 has two switches 232 for being turned on, and the fixed plate 216 has two opening 216b exposing the two switches 232 respectively for the touch module 220 to touch the switches 232. It is noticed that the way to bend the side 220a of the touch module 220 for turning on the switch module 230 is similar to the way shown in FIG. 4.

Equally, the switch module 230 is disposed under the touch module 220. Therefore, the switch module 230 does not occupy the area on the housing 210, such that the size and the operation area of the touch sensitive 220 are able to be increased.

Referring to FIG. 5 and FIG. 6, the touch module 220 includes a touch sensor 224 adhered to the supporting plate 226 for protecting the touch sensor 224. The supporting plate 226 is disposed on the touch sensor 224, wherein the elastic connecting part 222 is extended from a first side 226a of the supporting plate 226. The touch module 220 further includes an adhesive layer 228, disposed between the supporting plate 226 and the touch sensor 224, such that the supporting plate 226 and the touch sensor 224 are fixed together.

In addition, the supporting plate 226 has at least an engaged portion 226c (showing three), extended from a second side 226b of the top cover 226 and contacted with an inner wall 218 of the housing 210 in the opening 212, wherein the second side 226b is opposite to the first side 226a. The engaged portions 226c are able to limit the position of the touch module 220 for preventing the side 220a of the touch module 220 from being raised from the housing 210.

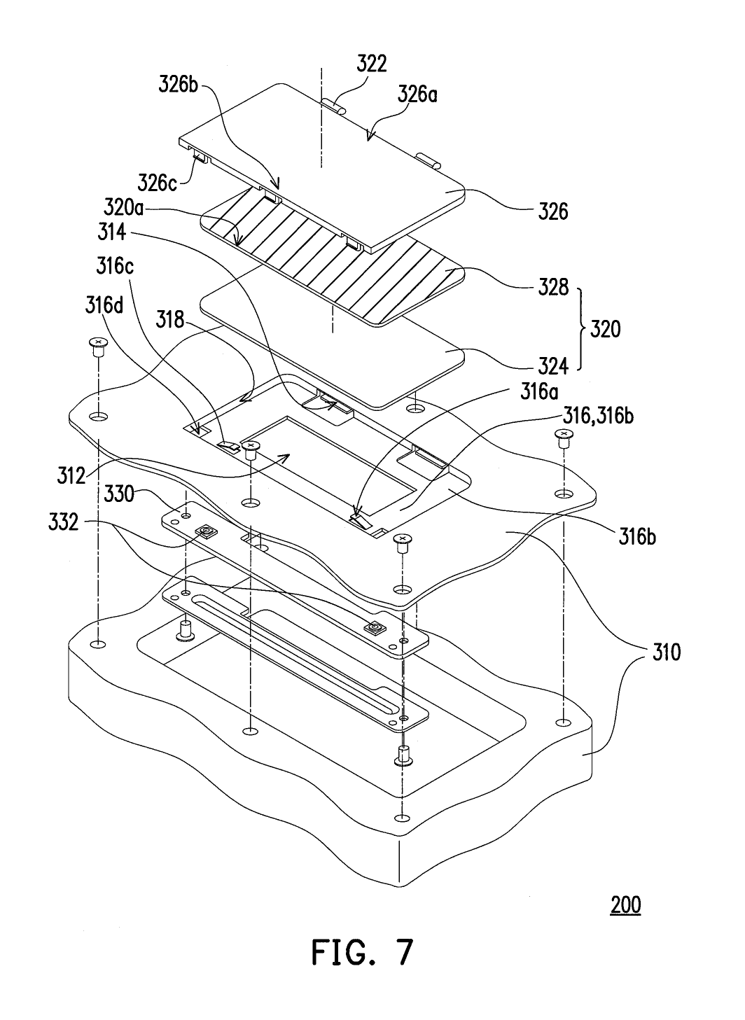

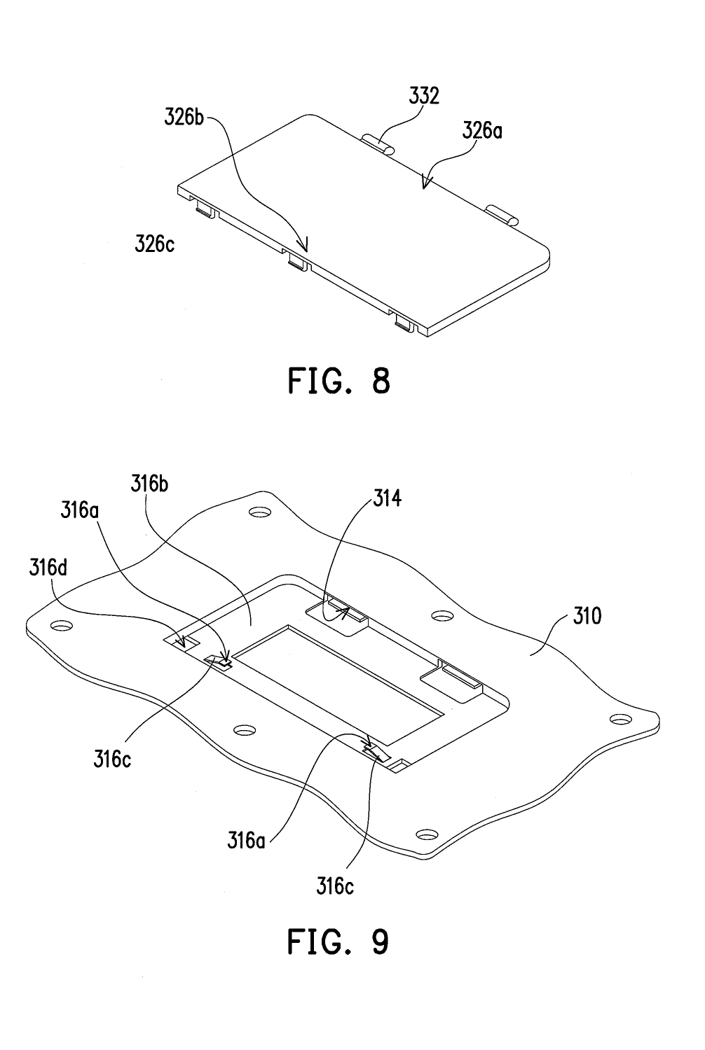

FIG. 7 is an exploded view showing another embodiment of parts of the electronic device of the present invention. FIG. 8 is a schematic perspective view showing the top cover in FIG. 7. FIG. 9 is a schematic perspective view showing the housing in FIG. 7. Referring to FIG. 7, FIG. 8 and FIG. 9, the electronic device 300 includes a housing 310, a touch module 320 and a switch module 330. The housing 310 has an opening 312, a supporting plate 326, at least a first pivot portion 314 (showing two) in the opening 312 and an elastic structure 316 fixed in the opening 312, wherein the elastic structure 316 has a supporting surface 316a exposing under the opening 312. The housing 310 could be a part of a shell of a notebook computer. In other words, the housing 310 is able to be integrated with a shell of a notebook computer by manufacturing.

The touch module 320 is adhered to the supporting plate 326, wherein the touch module 320 is supported by the supporting surface 316a and apt to be pressed over the elastic structure 316. The supporting plate 326 has at least a second pivot portion 322 (showing two) pivoted to the first pivot portion 314. The switch module 330 is disposed in the housing 310 and corresponding to a side 320a of the touch module 320, wherein the side 320a of the touch module 320 is opposite to the second pivot portion 322 and suitable for being bent by the elastic deformation of the elastic structure 316 to turn on the switch module 330 by a force applied to the side 320a of the touch module 320. In this embodiment, the switch module 330 has two switches 332 for being turned on, and the fixed plate 316b has two opening 316d exposing the two switches 332 respectively for the touch module 320 to touch the switches 332. It is noticed that the way to bend the side 320a of the touch module 320 for turning on the switch module 330 is similar to the way shown in FIG. 4.

Equally, the switch module 330 is disposed under the touch module 320. Therefore the switch module 330 does not occupy the area on the housing 310, such that the size and the operation area of the touch sensitive 320 are able to be increased.

Referring to FIG. 7 and FIG. 8, the touch module 320 includes a touch sensor 324 adhered to the supporting plate 326 for protecting the touch sensor 324. The supporting plate 326 is disposed on the touch sensor 324, wherein the second pivot portion 322 is extended from a first side 326a of the supporting plate 326. The touch module 320 further includes an adhesive layer 328, disposed between the supporting plate 326 and the touch sensor 324, such that the supporting plate 326 and the touch sensor 324 are fixed together.

In addition, the supporting plate 326 has an engaged portion 326c, extended from a second side 326b of the supporting plate 326 and contacted with an inner wall 318 of the housing 310 in the opening 312, wherein the second side 326b is opposite to the first side 326a. The engaged portions 326c are able to limit the position of the touch module 320 for preventing the side 320a of the touch module 320 from being raised from the housing 310.

Specially, referring to FIG. 7 and FIG. 9, the elastic structure 316 includes a fixed plate 316b and at least an elastic element 316c (showing two). The fixed plate 316b is fixed in the opening 312. The elastic elements 316c are disposed on the fixed plate 316b and have the supporting surface 316a. In this embodiment, each elastic element 316c is for example an elastic arm connected to the fixed plate 316b. The elastic elements 316c are elastically deformed while a force is applied to the side 320a of the touch module 320, such that the side 320a of the touch module 320 is able to indirectly bend to turn on the switch module 330.

In summary, the switch module of the present invention is disposed under the touch module and is able to be turned on directly or indirectly by a side of the touch module when a force is applied to the touch module. Thus, the operation area of the touch module is able to be increased and the arrangement of the touch module is more flexible since the switch module does not occupy the area on the housing. Besides, the manufacturing cost is decreased and the manufacturing process is simplified since it is no need to dispose a button on the housing for pressing the switch module.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a housing, having an opening and a supporting plate, wherein one side of the supporting plate is connected to the housing;
a touch module, disposed over the supporting plate and one side connected to the housing; and
a switch module, disposed under the supporting plate and corresponding to a side of the touch module, wherein the side of the touch module is bent to turn on the switch module when a force is applied to the side of the touch module.

2. The electronic device as claimed in claim 1, wherein the supporting plate is integrated with the housing.

3. The electronic device as claimed in claim 2, wherein the touch module comprises:
a touch sensor, disposed on the surface of the supporting plate and is over the supporting plate; and
a top cover, disposed on the touch sensor.

4. The electronic device as claimed in claim 3, wherein the touch module further comprises:
a first adhesive layer, disposed between the top cover and the touch sensor; and
a second adhesive layer, disposed between the supporting plate and the touch sensor.

5. The electronic device as claimed in claim 1, wherein the housing has at least a slot under the opening, and the supporting plate has at least an elastic connecting part inserted into the slot and connected to the housing, wherein the elastic connecting part is extended from a first side of the supporting plate and the side of the touch module is opposite to the elastic connecting part.

6. The electronic device as claimed in claim 5, wherein the touch module comprises:
a touch sensor, disposed on the surface of the supporting plate and is under the supporting plate.

7. The electronic device as claimed in claim 6, wherein the touch module further comprises:
An adhesive layer, disposed between the supporting plate and the touch sensor.

8. The electronic device as claimed in claim 5, wherein the supporting plate has an engaged portion, extended from a second side of the supporting plate and contacted with an inner wall of the housing in the opening, wherein the second side is opposite to the first side.

9. The electronic device as claimed in claim 1, wherein the housing has at least a first pivot portion in the opening and an elastic structure fixed in the opening, and the supporting plate has at least a second pivot portion extended from a first side of the supporting plate and pivoted to the first pivot portion, wherein the side of the touch module is opposite to the second pivot portion, and the supporting plate is supported by the elastic structure.

10. The electronic device as claimed in claim 9, wherein the touch module comprises:
a touch sensor, disposed on the surface of the supporting plate and is under the supporting plate.

11. The electronic device as claimed in claim 10, wherein the touch module further comprises:
An adhesive layer, disposed between the supporting plate and the touch sensor.

12. The electronic device as claimed in claim 9, wherein the supporting plate has an engaged portion, extended from a second side of the top cover and contacted with an inner wall of the housing in the opening, wherein the second side is opposite to the first side.

13. The electronic device as claimed in claim 9, wherein the elastic structure comprises:
a fixed plate, fixed in the opening; and
at least an elastic element, disposed on the fixed plate.
